(19) United States
(12) Patent Application Publication
(10) Pub. No.: US 2015/0138486 A1
(43) Pub. Date: May 21, 2015

(54) DIRECTIONAL BACKLIGHT UNIT, METHOD OF OPERATING THE DIRECTIONAL BACKLIGHT UNIT, AND DISPLAY DEVICE INCLUDING THE DIRECTIONAL BACKLIGHT UNIT

(71) Applicant: Electronics and Telecommunications Research Institute, Daejeon (KR)

(72) Inventor: Sei Hyoung LEE, Gwangju (KR)

(73) Assignee: Electronics and Telecommunications Research Institute, Daejeon (KR)

(21) Appl. No.: 14/340,021

(22) Filed: Jul. 24, 2014

(30) Foreign Application Priority Data
Nov. 20, 2013 (KR) 10-2013-0141488

(51) Int. Cl. G02F 1/29; G02F 1/1335

(52) U.S. Cl. CPC G02F 1/29; G02F 1/133606; G02F 2001/133607
USPC 349/62; 359/298

(57) ABSTRACT

Provided are a directional backlight unit, a method of operating the directional backlight unit, and a display device. More particularly, provided are a directional backlight unit including a light source, a first optical plate layer disposed to be adjacent to the light source, a second optical plate layer disposed on the first optical plate layer and to which light from the light source is incident, and an optical sheet through which light emitted from the second optical plate layer passes, a method of operating the directional backlight unit, and a display device including the directional backlight unit.

### CROSS-REFERENCE TO RELATED APPLICATION

This application claims the priority benefit of Korean Patent Application No. 10-2013-0141488, filed on Nov. 20, 2013, in the Korean Intellectual Property Office, the disclosure of which is incorporated herein by reference.

### BACKGROUND

1. Field of the Invention

Embodiments of the present invention relate to a directional backlight unit, a method of operating the directional backlight unit, and a display device including the directional backlight unit.

2. Description of the Related Art

A backlight unit emits white light including red light, green light, and blue light, and has been used for a light emitting display device, an information communication device, a light source for displaying an image, and the like. The backlight unit uses a cold cathode florescent lamp (CCFL), a semiconductor light emitting device such as a gallium nitride compound, and the like. Currently, interest on a directional backlight has been increasing with the development of technology on a three-dimensional (3D) display.

As an example of the directional backlight according to the related art, a directional backlight disclosed in US 2011/0285927 allows one of two light sources of a backlight unit to be incident to a light guide and includes a redirecting film in order to transmit light of the directional backlight to a predetermined direction, for example, a right eye (RE) and a left eye (LE). In the above structure, an area in which it is possible to view a 3D image is fixed by a device and thus, a user needs to position the user's eyes at a predetermined area in order to view the 3D image. If positions of the eyes change, a parallax area may occur in the 3D image. Also, as another example of the directional backlight according to the related art, US 2012/0314145 discloses a backlight unit using a method of transmitting light of the backlight unit in a predetermined direction. However, the above method may limit an area for viewing a 3D image since an area in which the backlight unit may transmit light is fixed due to a structure to which a light source array is mounted.

### SUMMARY

An aspect of the present invention provides a directional backlight unit capable of adjusting a direction of light and a transfer area of light emitted from the directional backlight to unit, based on a change in a position of a user, a method of operating the directional backlight unit, and a display device including the backlight display unit.

Objects to be achieved by the invention are not limited to the aforementioned objects and thus, other objects not described herein will be clearly understood by a person of ordinary skill from the following description.

According to an aspect of the present invention, there is provided a directional backlight unit, including a light source, a first optical plate layer disposed to be adjacent to the light source, a second optical plate layer disposed on the first optical plate layer and to which light from the light source is incident, and an optical sheet through which light emitted from the second optical plate layer passes. A variable grating portion may be formed on the second optical plate layer.

A direction of the light emitted from the second optical plate layer may be adjusted by changing at least one of a grating period and a curvature of the variable grating portion.

A grating period of the variable grating portion may change based on at least one of voltage, current, ultrasound, magnetic field, and heat. Also, a curvature of the variable grating portion may change based on at least one of voltage, current, magnetic field, ultrasound, and heat.

The directional backlight unit may further include a controller configured to control a grating period and a curvature of the variable grating portion based on an external signal. Also, the controller may be configured to control at least one of voltage, current, magnetic field, ultrasound, and heat to be applied to the variable grating portion.

According to another aspect of the present invention, there is provided a method of operating a directional backlight unit, the method including allowing light emitted from a light source to be incident to a second optical plate layer on which a variable grating portion is formed, detecting a position of a user, and adjusting a direction of light emitted from the second optical plate layer based on the detected position of the user by consecutively to changing a grating period of the variable grating portion.

The grating period of the variable grating portion may change based on at least one of voltage, current, magnetic field, ultrasound, and heat. Also, the adjusting may include changing a curvature of the variable grating portion. Also, the changing may include changing the curvature of the variable grating portion based on at least one of voltage, current, magnetic field, ultrasound, and heat.

According to still another aspect of the present invention, there is provided a display device, including a directional backlight unit of the present invention, and a display panel configured to display an image using light emitted from the directional backlight unit. The display panel may include a liquid crystal layer and a color filter layer disposed on the liquid crystal layer.

According to embodiments of the present invention, a directional backlight unit may adjust light to be emitted in a desired direction and a desired area.

Also, according to embodiments of the present invention, a directional backlight unit may decrease an amount of power used since there is no need to transmit light to an unnecessary area.

Also, according to embodiments of the present invention, a display device including a directional backlight unit may simultaneously display different images to the respective users when a plurality of users is simultaneously present.

Also, according to embodiments of the present invention, a display device including a directional backlight unit may enable a user to view a 3D image by consecutively changing an emission direction of light.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a cross-sectional view of a directional backlight unit according to an embodiment of the present invention.

FIGS. 2A and 2B are views describing an example of adjusting a direction of light emitted from a directional backlight unit according to an embodiment of the present invention.

FIGS. 3A and 3B are views describing another example of adjusting a direction of light emitted from a directional backlight unit according to an embodiment of the present invention.

FIG. 4 is a view describing an example of adjusting an area in which light of a directional backlight unit is emitted according to an embodiment of the present invention.

FIG. 5 is a cross-sectional view of a directional backlight unit according to an embodiment of the present invention.

FIG. 6 is a cross-sectional view of a display device including a directional backlight unit according to an embodiment of the present invention.

### DETAILED DESCRIPTION

Hereinafter, embodiments of the present invention will be described with reference to the accompanying drawings. When it is determined detailed description related to a related known function or configuration they may make the purpose of the present invention unnecessarily ambiguous in describing the present invention, the detailed description will be omitted here. Also, terminologies used herein are defined to appropriately describe the embodiments of the present invention and thus may be changed depending on a user, the intent of an operator, or a custom. Accordingly, the terminologies must be defined based on the following overall description of this specification. Like reference numerals illustrated in the drawings refer to like constituent elements throughout the specification.

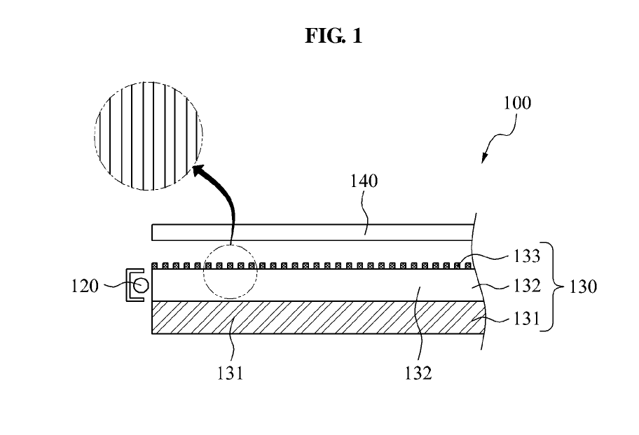

Embodiments of the present invention relate to a directional backlight unit 100, which will be described with reference to FIG. 1.

FIG. 1 is a cross-sectional view of the directional backlight unit 100 according to an embodiment of the present invention.

The directional backlight unit 100 may control a direction of light and a transfer area of light of the directional backlight unit 100.

The directional backlight unit 100 may include a light source 120, an optical plate portion 130, and an optical sheet portion 140. The light source 120 may be disposed on one side or each of both sides of the optical plate portion 130 to emit light, and may include a linear light source or a surface light source. For example, the light source 120 may be a hot cathode florescent lamp, a cold cathode florescent lamp (CCFL), a light emitting diode (LED), an organic light emitting diode (OLED), a laser diode, an external electrode florescent lamp (EEFL), and the like.

The optical plate portion 130 may adjust a direction of light emitted from the light source 120 and may forma a surface light source. Referring to FIG. 1, the optical plate portion 130 may include a first optical plate layer 131 and a second optical plate layer 132.

The first optical plate layer 131 may be disposed below the second optical plate layer 132 to emit light over the entire second optical plate layer 132 without losing the light emitted from the light source 120. For example, the first optical plate layer 131 may be formed of a material having a relatively low refractive index compared to a constituent material of the second optical plate layer 132. Accordingly, it is possible to minimize the loss of light incident to the second optical plate layer 132 and to enable high luminance light to be emitted from the second optical plate layer 132.

When the light emitted from the light source 120 is incident to the second optical plate layer 132, the second optical plate layer 132 may guide the light to be emitted as a surface light source. In particular, in the case of emitting the light, the second optical plate layer 132 may adjust an emission angle of light and the range of an emission area of light based on a direction of a user. A variable grating portion 133 may be formed on the second optical plate layer 133 and may adjust a direction of light emitted from the second optical plate layer 132 and an area range of light transferred in a predetermined direction, based on a change in at least one of a grating period and a curvature of the variable grating portion 133. For example, the grating period of the variable grating portion 133 may change based on at least one of voltage, current, magnetic field, ultrasound, and heat, and the variable grating portion 133 may adjust an emission angle of light.

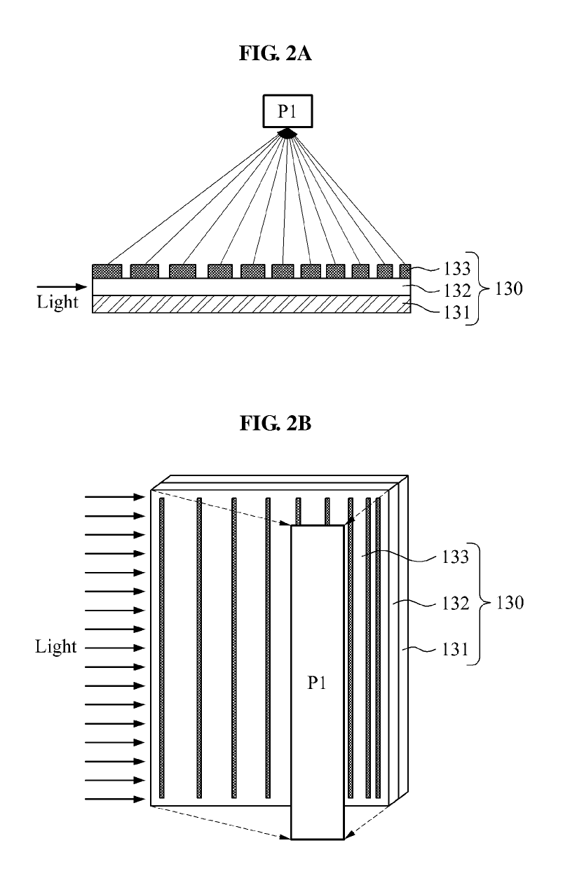

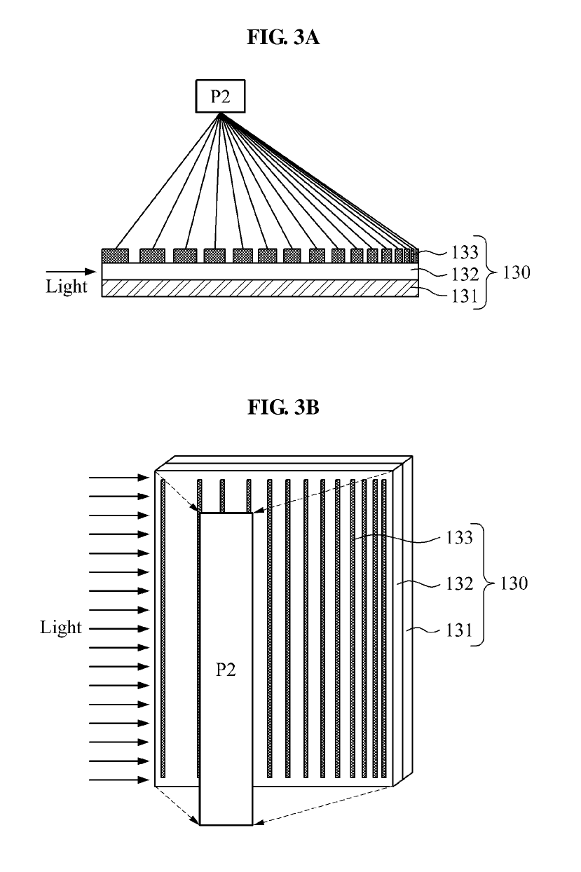

Hereinafter, an example of adjusting a direction of light emitted from a directional backlight unit according to an embodiment of the present invention will be described with reference to FIGS. 2A through 3B.

FIGS. 2A and 2B are views describing an example of adjusting a direction of light emitted from the directional backlight unit 100 according to an embodiment of the present invention. Referring to FIGS. 2A and 2B, an emission angle of light may be adjusted by changing a grating period of the variable grating portion 133 so that the light of the directional backlight unit 100 may face towards a first viewing direction P1.

FIGS. 3A and 3B are views describing another example of adjusting a direction of light emitted from the directional backlight unit 100 according to an embodiment of the present invention. Referring to FIGS. 3A and 3B, an emission angle of light may be adjusted by changing a grating period of the variable grating portion 133 so that the light of the directional backlight unit 100 may face towards a second viewing direction P2.

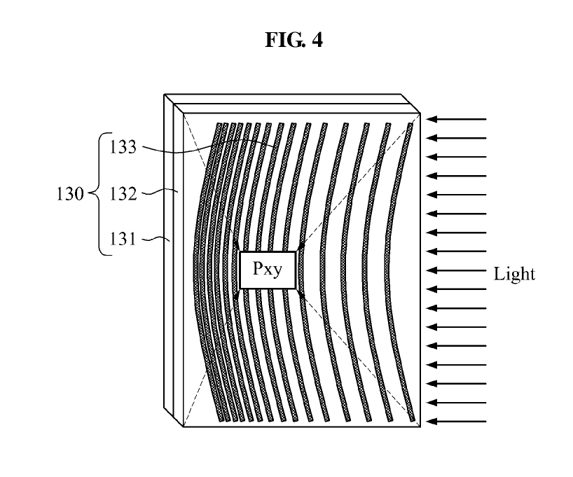

Also, the emission range of light in a predetermined area may be adjusted based on an X-Y axial direction by changing a curvature of the variable grating portion 133. FIG. 4 is a view describing an example of adjusting an area in which light of the directional backlight unit 100 is emitted according to an embodiment of the present invention. Referring to FIG. 4, an emission angle of light may be adjusted by changing a grating period of the variable grating portion 133 so that light of the directional backlight unit 100 may face towards a predetermined direction. An X-Y axial direction of emitted light may be adjusted by to changing a curvature of the variable grating portion 133 so that the emission range of light towards the predetermined direction may be within a first area, for example, Pxy.

The grating period of the variable grating portion 133 may be adjusted by changing a refractive index based on at least one of voltage, current, magnetic field, ultrasound, and heat. The curvature of the variable grating portion 133 may be adjusted based on at least one of voltage, current, ultrasound, magnetic field, and heat.

The variable grating portion 133 may be formed on the second optical plate layer 132. The second optical plate layer 132 may enable light incident from the light source 120 to be emitted at high luminance. The second optical plate layer 132 may include a material of which an optical characteristic is adjusted and thereby of which a grating period and a curvature based on at least one of voltage, current, magnetic field, ultrasound, and heat.

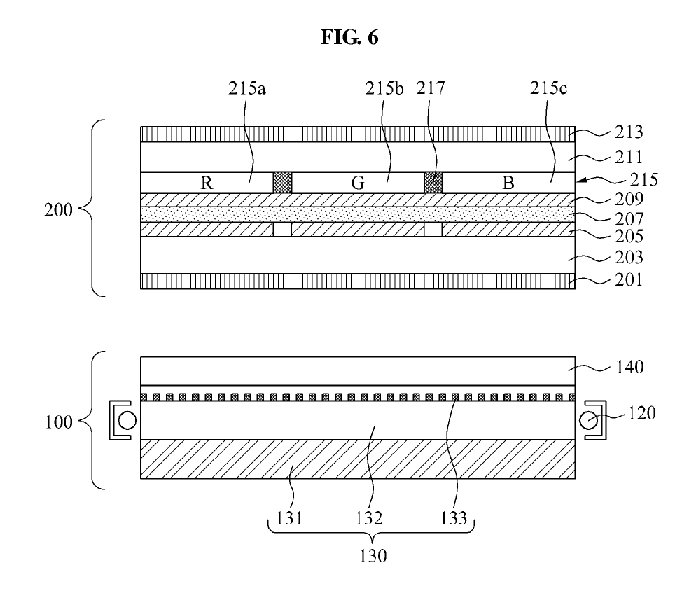

The optical sheet portion 140 may be disposed on the second optical plate layer 132 to process the light emitted from the second optical plate layer 132 as a uniform surface light source or enhance luminance of light and appearance quality and then supply the light to a display panel 200 of FIG. 6. The optical sheet portion 140 may include an integrated optical sheet to be available for the directional backlight unit 100. Such an optical sheet may provide a function such as refraction of light, collection of light, and diffusion of light, for example. Although not illustrated, the optical sheet portion 140 may include a diffuser sheet configured to diffuse the light emitted from the second optical plate layer 132 and a prism sheet configured to collect the light diffused by the diffuser sheet. Also, the optical sheet portion 140 may further include a protection sheet disposed on the prism sheet to protect the prism sheet. In addition, the optical sheet portion 140 may further include a generally used optical sheet, for example, a polarizing plate, a phase difference film, a light collecting sheet, and a window film. Any configuration applicable in the art may be employed for a configuration of the optical sheet portion 140.

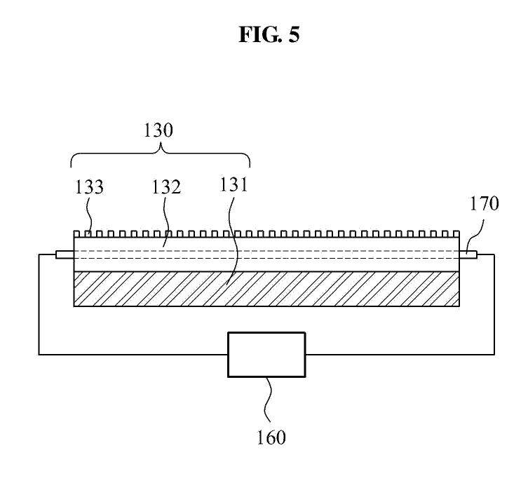

FIG. 5 is a cross-sectional view of the directional backlight unit 100 according to an embodiment of the present invention.

Referring to FIG. 5, the directional backlight unit 100 may include a controller 160, the optical plate sheet portion 130, and a transparent heater electrode 170. The optical plate sheet portion 130 may include the first optical plate layer 131, the second optical plate layer 132, the variable grating portion 133,

The controller 160 may change a grating period and a curvature of the variable grating portion 133 by applying at least one of voltage, current, magnetic field, ultrasound, and heat to the second optical plate layer 132 based on an external signal in which a position of a user is detected, and by changing an optical characteristic of the variable gird portion 133. For example, the controller 160 may be a heat supplier, a current supplier, and the like. In detail, a transparent electrode or the transparent heater electrode 170 may be introduced within the second optical plate layer 132, and a refractive index of the variable grating portion 133 may be adjusted by supplying current or heat using the controller 160.

The position of the user may be detected through a sensor attached to a display device including the directional backlight unit 100 according to an embodiment of the present invention. The present invention does not particularly limit a configuration of the sensor.

According to an embodiment of the present invention, a method of operating a directional backlight unit may include allowing light to be incident to a second optical plate layer, detecting a position of a user, and adjusting a direction of light.

The allowing of the light to be incident to the second optical plate layer may include allowing light emitted from an adjacent light source to be incident to the second optical plate layer.

The detecting of the position of the user may include detecting the position of the user using a sensor mounted to a display device.

The adjusting of the direction of light may include adjusting a direction of light emitted from the second optical plate layer by consecutively changing a grating period of the to variable grating portion. By consecutively changing the grating period in response to a change in the position of the user, the direction of light may be adjusted based on the changed position of the user. Also, when a plurality of users is present, the direction of light may be adjusted by consecutively changing the grating period and different images may be displayed using a display panel based on the direction of light so that the plurality of users may view an image at the respective corresponding positions.

The adjusting of the direction of light may further include changing the curvature of the variable grating portion and adjusting the range of an area range in which the light is emitted, based on the position of the user.

According to an embodiment of the present invention, a display device including a directional backlight unit constructed as above may be provided. Any type of display devices to which the directional backlight unit is applicable may be employed. For example, an LCD device, an LED display device, and an electronic paper may be employed. Also, an LCD device for displaying a 3D image may be employed.

Hereinafter, a display device including a directional backlight unit according to an embodiment of the present invention will be described with reference to FIG. 6.

FIG. 6 is a cross-sectional view of a display device including the directional backlight unit 100 according to an embodiment of the present invention.

Referring to FIG. 6, the display device may include the directional backlight unit 100 and the display panel 200 configured to display an image using light emitted from the directional backlight unit 100. The display panel 200 may include a liquid crystal layer 207 and a color filter layer 215. The directional backlight unit 100 may include the light source 120, the optical plate portion 130, and the optical sheet portion 140.

In detail, the display panel 200 may include the liquid crystal layer 207 and the color filter layer 215 that includes red (R) 215a, green (G) 215b, and blue (B) 215c for color realization.

The liquid crystal layer 207 may be formed on a thin film transistor (TFT) array substrate. The TFT array substrate may include a TFT (not shown), a pixel electrode 205 configured to control a transmissivity of light, a lower glass substrate 203 disposed below the pixel electrode 205, and a lower polarizing plate 201 disposed below the lower glass substrate 203 to polarize light emitted from the directional backlight unit 100.

The color filter layer 215 may be configured to realize a color image and be formed on a common electrode 209, and may include a black matrix 217 configured to block the leakage of light. An upper glass substrate 211 may be disposed on the color filter layer 215 and an upper polarizing plate 213 configured to polarize light having passed through the color filter layer 215 may be disposed on the upper polarizing plate 213.

A display device including a directional backlight unit according to embodiments of the present invention may be manufactured by adopting a process known in the art and thus, the present invention does not particularly limit a manufacturing method thereof. Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A directional backlight unit, comprising:
a light source;
a first optical plate layer disposed to be adjacent to the light source;
a second optical plate layer disposed on the first optical plate layer and to which light from the light source is incident; and
an optical sheet through which light emitted from the second optical plate layer passes,
wherein a variable grating portion is formed on the second optical plate layer.

2. The directional backlight unit of claim 1, wherein a direction of the light emitted from the second optical plate layer is adjusted by changing at least one of a grating period and a curvature of the variable grating portion.

3. The directional backlight unit of claim 1, wherein a grating period of the variable grating portion changes based on at least one of voltage, current, ultrasound, magnetic field, and heat.

4. The directional backlight unit of claim 1, wherein a curvature of the variable grating portion changes based on at least one of voltage, current, magnetic field, ultrasound, and heat.

5. The directional backlight unit of claim 1, wherein the optical sheet corresponds to a diffuser sheet or a prism sheet.

6. The directional backlight unit of claim 1, further comprising:
a controller configured to control a grating period and a curvature of the variable grating portion based on an external signal.

7. The directional backlight unit of claim 1, wherein the controller is configured to control at least one of voltage, current, magnetic field, ultrasound, and heat to be applied to the variable grating portion.

8. A method of operating a directional backlight unit, the method comprising:
allowing light emitted from a light source to be incident to a second optical plate to layer on which a variable grating portion is formed;
detecting a position of a user; and
adjusting a direction of light emitted from the second optical plate layer based on the detected position of the user by consecutively changing a grating period of the variable grating portion.

9. The method of claim 8, wherein the grating period of the variable grating portion changes based on at least one of voltage, current, magnetic field, ultrasound, and heat.

10. The method of claim 8, wherein the adjusting comprises changing a curvature of the variable grating portion.

11. The method of claim 10, wherein the changing comprises changing the curvature of the variable grating portion based on at least one of voltage, current, magnetic field, ultrasound, and heat.

12. A display device, comprising:
a directional backlight unit according to claim 1; and
a display panel configured to display an image using light emitted from the directional backlight unit,
wherein the display panel comprises a liquid crystal layer and a color filter layer disposed on the liquid crystal layer.
